(19) United States
(12) Patent Application Publication
(10) Pub. No.: US 2008/0010109 A1
(43) Pub. Date: Jan. 10, 2008

(54) Equipment management system

(75) Inventor: Shigeaki Ide, Kumamoto (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KAWASAKI (JP)

(21) Appl. No.: 11/822,063

(22) Filed: Jul. 2, 2007

(30) Foreign Application Priority Data
Jul. 5, 2006 (JP) 2006-185391

(51) Int. Cl. G06F 17/18

(52) U.S. Cl. 705/10

(57) ABSTRACT

The system includes: an operation management server 20 and a lot history server 30, which collect operation status data showing operation statuses of a plurality of equipments 10; an OEE measuring PC 40 accumulating an actual processing time and a loss time from the operation status data of the plurality of equipments 10 on a predetermined period basis, and calculating overall equipment efficiencies for each predetermined period from the obtained accumulated-results; an equipment load factor calculating PC 50 accepting information on an improvement plan for the equipment, predicting a future overall equipment efficiency for each equipment according to the overall equipment efficiency and the information on the improvement plan, calculating the future group load factor based on the predicted future overall equipment efficiency; and a WEB server 60 storing equipment management information including the future overall equipment efficiency and the future equipment load factor for a plurality of equipments.

This application is based on Japanese Patent application NO. 2006-185391, the content of which is incorporated hereinto by reference.

### BACKGROUND

1. Technical Field

The present invention relates to an equipment management system, and, more particularly, to an equipment management system capable of managing an equipment investment plan or the like, based on an overall equipment efficiency (OEE) and an equipment load factor of a production equipment.

2. Related Art

A conventional equipment capacity calculation system for a production equipment includes, the system disclosed in Japanese Laid-Open Patent Publication No. H05-020333. The equipment capacity calculation system described in the above patent document calculates processing performance of an equipment with a complex structure and many functions like a semiconductor production device. And the calculation system is provided with an equipment specification management unit for registering and managing data for equipment management, a manufacturing condition management unit for registering and managing a product related data, and an equipment capacity calculation unit for calculating the processing performance. Data for equipment management and product related data are separated from each other for management, and data such as manufacturing flows and processing conditions of products, a non-operating time of an equipment for oil exchange and for checking, and an actual processing time varying according to the kinds and the processes of the products are registered beforehand. Based on the above data, the processing performance is calculated.

Moreover, Japanese Laid-Open Patent Publication No. 2000-123085 has disclosed a data accumulator which accumulates status data for production line operation, and obtains a production management index based on six large losses. The data accumulator disclosed in the above patent document has a configuration in which the operation status data of the equipment is collected and processed, wherein the status data is collected by the data collection terminal device, and a chart showing a relation between a plurality of stop factors and the stop generation time is made, based on the operation status data, for output. Japanese Laid-Open Patent Publication No. 8-229779 has disclosed a production-line configuration evaluation device for automatic optimization of design change of a production line.

However, conventional technologies disclosed in the above-described patent documents have had room for improvement as will be described in the following:

In the first place, the above technologies have a configuration in which data for equipment management is registered beforehand, various kinds of data on an equipment is input from an input device, but an actual processing time and a loss time are not automatically measured. In order to obtain the actual processing time and the loss time for each equipment, an engineer is required to be by the equipment in a manufacturing device for a predetermined period and to manually measure the time while confirming operation of the equipment. Accordingly, it has been difficult to obtain all data for from several hundreds to several thousands of manufacturing devices.

In the second place, it has been also difficult to continue the operation in which the above measurement is periodically repeated for the long term to obtain up-to-the-minute information at all times. Accordingly, a tendency over time of the actual processing time and the loss time has not been able to be obtained, and a load factor based on an overall equipment efficiency has not been able to be calculated with high accuracy.

In the third place, a period of half year or more is required for ordering to start-up through delivery of a semiconductor production equipment. Accordingly, ordering is required to be made half year or more in advance when an equipment investment is required, and an equipment load factor for an equipment infusion plan from a half year to one year into the future is required to be calculated. However the system according to the conventional technologies described in the above-described patent document has not had a function for the above calculation.

### SUMMARY

According to the present invention, there is provided an equipment management system, including: a collection unit collecting operation status data indicating operation statuses of a plurality of equipments; an accumulating unit accumulating an actual processing time and a loss time from the operation status data on a predetermined period basis; an overall equipment efficiency calculating unit calculating an overall equipment efficiency from the accumulated result obtained by the accumulating unit on a predetermined period basis; an accepting unit accepting information on an improvement plan for the equipment; a prediction unit predicting a future overall equipment efficiency according to the overall equipment efficiency and the information on the improvement plan; an equipment load factor calculating unit calculating a future equipment load factor, based on the future overall equipment efficiency predicted by the prediction unit; and a storage unit storing equipment management information, which includes the future overall equipment efficiency and the future equipment load factor, for a plurality of equipments.

Here, the operation status data may include information indicating operation statuses of a plurality of equipments under operating, and information indicating work operation histories for each product lot. The actual processing time may be accumulated, using information acquired from a host computer controlling each equipment, and a database storing information on each equipment. The loss time means eight segment loss time, and includes a scheduled maintenance loss, a failure loss, a changeover, a setup, a test time, an idle time, a speed loss, and a rework loss. Moreover, each loss time may be measured from information on the operation statuses and the work operation histories.

According to the present invention, OEEs and equipment load factors in the future may be efficiently calculated for a plurality of equipments under operating. That is, the operation statuses of a plurality of equipments under operating may be automatically collected, OEEs in the future may be predicted from the OEEs accumulated in a regular base according to the improvement plan, equipment load factors in the future may be calculated, based on the predicted results, and the above information may be stored to contribute to an equipment infusion plan in the future.

Here, arbitrary combinations of the above constitutional elements, and ones obtained by converting expression of the present invention among a method, a device, a system, a recording mediums, a computer program, and the like also are effective as an aspect of the present invention.

According to the present invention, there is provided an equipment management system by which an overall equipment efficiency and an equipment load factor in the future for a plurality of equipments under operating may be efficiently calculated with excellent accuracy.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing the configuration of an equipment management system according to an embodiment of the present invention;

FIG. 2 is a functional block diagram showing details of an OEE measuring PC in the equipment management system shown in FIG. 1;

FIG. 3 is a view showing one example of a registration ledger stored in a registration ledger storage unit of the OEE measuring PC shown in FIG. 2;

FIG. 4 is a view showing one example of an OEE matrix table created by the OEE measuring PC shown in FIG. 2;

FIG. 5 is a functional block diagram showing details of an equipment load factor calculating PC in the equipment management system shown in FIG. 1;

FIGS. 6A and 6B are views showing examples of an improvement plan table in the equipment load factor calculating PC shown in FIG. 5;

FIG. 7 is a view showing one example of an equipment load factor list in the equipment load factor calculating PC shown in FIG. 5;

FIGS. 8A through 8C are views showing examples of other lists created by the equipment load factor calculating PC shown in FIG. 5;

FIG. 9 is a flow chart showing one example of a processing flow of the equipment management system according to the present embodiment;

FIG. 10 is a flow chart showing one example of a trend graph subroutine in the flow chart shown in FIG. 9;

FIG. 11 is a flow chart showing one example of an equipment load factor calculating subroutine in the flow chart shown in FIG. 9;

FIG. 12 is a view showing an accumulation graph as one example of an OEE trend graph, using an equipment “A” according to the present embodiment as an example;

FIG. 13 is a view showing one example of an OEE trend graph, using the equipment “A” according to the present embodiment as an example, and OEEs are steadily changed therein;

FIG. 14 is a view showing one example of an OEE trend graph, using the equipment “B” according to the present embodiment as an example, and OEEs continuously rise therein;

FIG. 15 is a view showing one example of an OEE trend graph, using the equipment “C” according to the present embodiment as an example, and the OEE is suddenly increased or decreased therein; and

FIGS. 16A through 16C are drawings explaining predicted results of OEE changes for improvement plans of each equipment according to the present embodiment.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Hereinafter, embodiments according to the present invention will be explained, with reference to drawings. Here, constitutional elements similar to those in all the drawings will be denoted by similar reference numerals, and description will not be repeated.

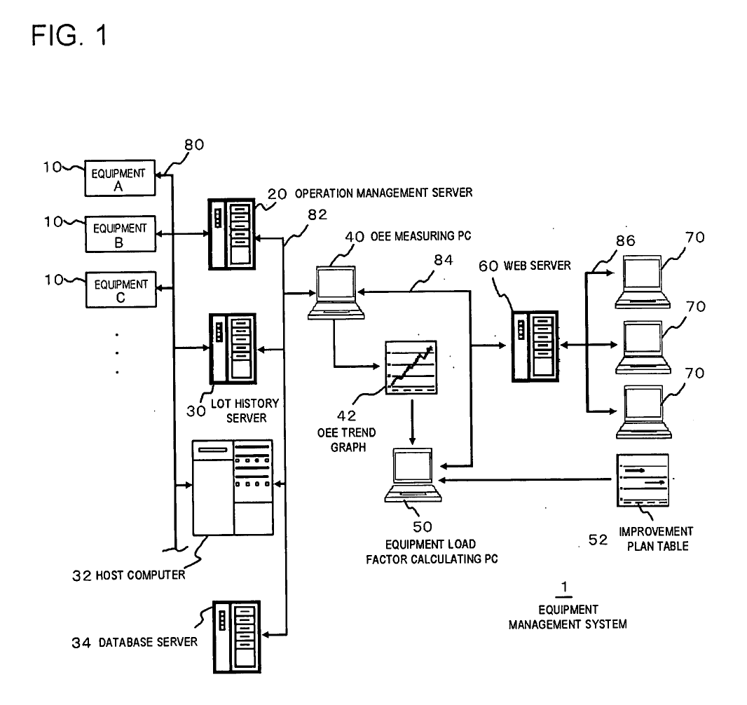

FIG. 1 is a block diagram showing the configuration of an equipment management system 1 according to an embodiment of the present invention. The equipment management system 1 according to the present embodiment comprises: a plurality of equipment groups 10 (equipment “A”, equipment “B”, and equipment “C” shown in the drawing) in a semiconductor manufacturing factory; an operation management server 20; a lot history server 30; a host computer 32; a database server 34; an OEE measuring personal computer (hereinafter, abbreviated as “PC”) 40; an equipment load factor calculating PC 50; a WEB server 60; and a plurality of terminals 70. Here, configurations for portions not related with the essence of the present invention will be eliminated in all the drawing shown hereinafter.

The equipment management system 1 in the present embodiment is preferably applied for a semiconductor production equipment, that is, a production equipment which requires a longer period for ordering to start-up through delivery and a long-range plan for equipment investment, and includes many manufacturing devices, for example, several hundreds to several thousands of manufacturing devices. According to the present embodiment of the equipment management system 1, an actual operation status may be automatically collected, and an equipment load factor may be efficiently and accurately calculated without requiring manual input of an enormous amount of long-term data corresponding to a lot of facilities.

Moreover, each constitutional element in the equipment management system 1 is realized by an arbitrary combination of software and hardware mainly including central processing units (CPUs) of arbitrary computers, memories, programs installed into the memories for realizing constitutional elements shown in the drawing, storage units such as hard disks reserving the programs and interfaces for network connection. Here, it will be appreciated by persons skilled in the art that methods and devices for realizing the above configuration have various kinds of variants. Each drawing which will be explained hereinafter shows not a configuration expressed by hardware units, but blocks as a functional unit.

The equipment management system 1 according to the present embodiment calculates a future equipment load factor, based on a predicted result which is obtained by collecting operation statuses of a plurality of equipments under operating in the automatic mode, and predicting a future OEE from OEEs, which have been regularly accumulated for each equipment, according to an improvement plan. The equipment management system 1 may accumulate the above information, and contribute to a future equipment infusion plan.

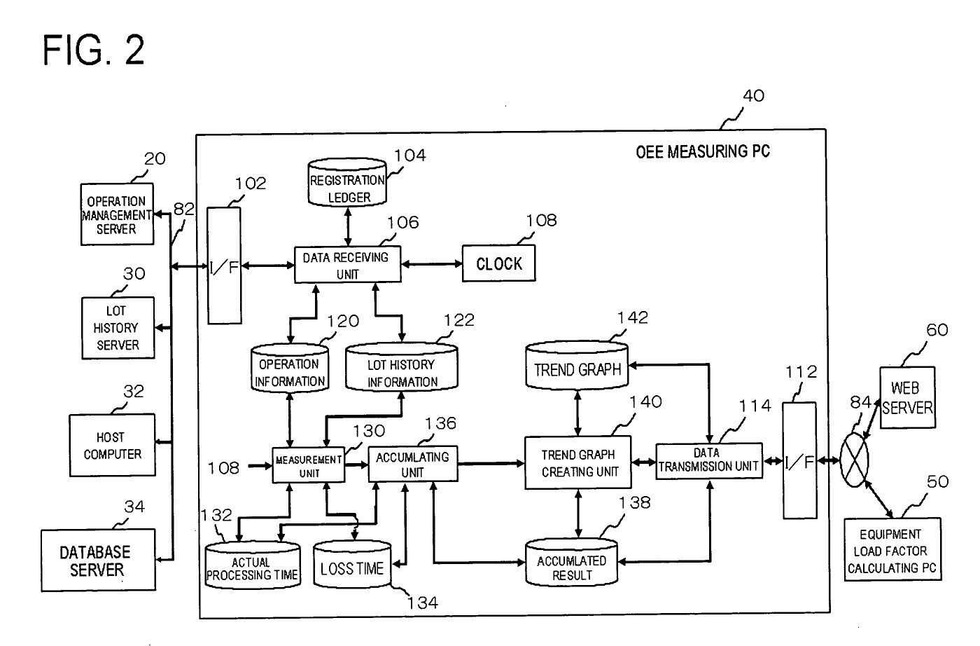

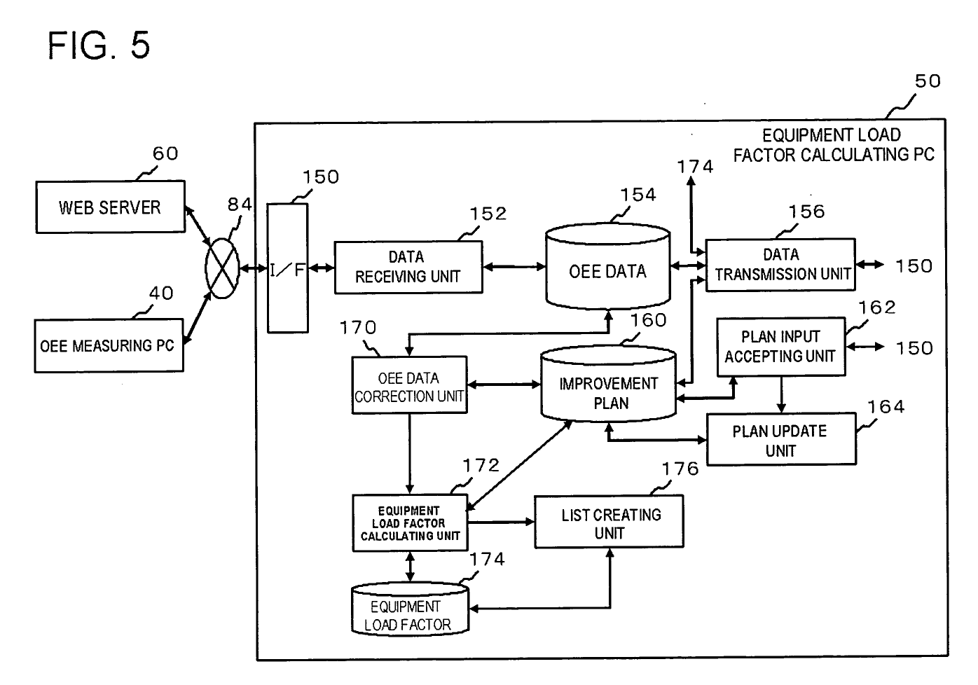

FIG. 2 is a functional block diagram showing details of the OEE measuring PC 40 in the equipment management system 1 shown in FIG. 1. FIG. 5 is a functional block diagram showing details of the equipment load factor calculating PC 50 in the equipment management system 1 shown in FIG. 1.

The equipment management system 1 according to the embodiment of the present invention comprises: a collection unit (an operation management server 20, a lot history server 30, a host computer 32, a database server 34, and a data receiving unit 106 in a OEE measuring PC 40) collecting operation status data, which indicates operation statuses of a plurality of equipments (in the equipment group 10); an accumulating unit (a measurement unit 130 and a clock 108 in the OEE measuring PC 40) accumulating an actual processing time and a loss time from the operation status data on a predetermined period basis; an overall equipment efficiency calculating unit (an accumulating unit 136 in the OEE measuring PC 40) calculating an overall equipment efficiency from the accumulated result obtained by the accumulating unit on the predetermined period basis; an accepting unit (a plan input accepting unit 162, and a plan update unit 164 in the equipment load factor calculating PC 50) accepting information on an improvement plan for the equipment; a prediction unit (an OEE data correction unit 170 in the equipment load factor calculating PC 50) predicting a future overall equipment efficiency for each equipment according to the overall equipment efficiency and the information on the improvement plan; an equipment load factor calculating unit (an equipment load factor calculating unit 172 in the equipment load factor calculating PC 50) calculating a future equipment load factor, based on the future overall equipment efficiency predicted by the prediction unit; and a storage unit (an accumulated result storage unit 138 in the OEE measuring PC 40, an equipment load factor storage unit 174 in the equipment load factor calculating PC 50, and a WEB server 60) storing equipment management information, which includes the future overall equipment efficiency and the future equipment load factor, for a plurality of equipments.

Here, in the present embodiment, the equipment management system 1 has had a configuration in which the OEE measuring PC 40 and the equipment load factor calculating PC 50 use different PCs, respectively, but the present invention is not limited to the above one. The OEE measuring PC 40 and the equipment load factor calculating PC 50 may be configured to use a same PC. Moreover, an example in which the OEE measuring PC 40 and the equipment load factor calculating PC 50 are configured by PCs will be explained, but the present invention is not limited to the above example. It is acceptable to adopt, for example, a dedicated computer, a workstation, and the like.

The equipment management system 1 according to the present embodiment may be realized by executing programs according to the present embodiment after installing the programs onto the OEE measuring PC 40 and the equipment load factor calculating PC 50. Hereinafter, the programs will be explained.

According to the programs according to the present embodiment, computers (the OEE measuring PC 40, and the equipment load factor calculating PC 50) accessible to a storage unit (the accumulated result storage unit 138 in the OEE measuring PC 40, the equipment load factor storage unit 174 in the equipment load factor calculating PC 50, and the WEB server 60) storing the equipment management information, including the overall equipment efficiency and the equipment load factor in the future, for a plurality of equipments function as means (the data receiving unit 106 in the OEE measuring PC 40) for collecting operation status data, which indicates the operation statuses of the plurality of equipments (the equipment group 10), means (the measurement unit 130 and the clock 108 in the OEE measuring PC 40) for accumulating the actual processing time and the loss time from the operation status data on a predetermined period basis, means (the accumulating unit 136 in the OEE measuring PC 40) for calculating the overall equipment efficiency from the accumulated result obtained by the accumulating means on a predetermined period basis, means (the plan input accepting unit 162, and the plan update unit 164 in the equipment load factor calculating PC 50) for accepting the information on the improvement plan for an equipment, means (the OEE data correction unit 170 in the equipment load factor calculating PC 50) for predicting the future overall equipment efficiency for each equipment according to the overall equipment efficiency and the information on the improvement plan, and means (the equipment load factor calculating unit 172 in the equipment load factor calculating PC 50) for calculating the future equipment load factor, based on the future overall equipment efficiency predicted by the prediction means.

As shown in FIG. 1, the plurality of the equipment groups 10, the operation management server 20, and the lot history server 30 are connected to one another through a network 80. Furthermore, the operation management server 20, the lot history server 30, the host computer 32, and the database server 34 are connected to the OEE measuring PC 40 through a network 82. The OEE measuring PC 40 and the equipment load factor calculating PC 50 are connected to the WEB server 60 through a network 84. The WEB server 60 is connected to the plurality of terminals 70 through a network 86. In the present embodiment, the WEB server 60 includes a connection unit (not shown in the drawing) connecting the WEB server 60 and the terminals 70 through the network 86 in such a way that the WEB server 60 is referred to from the terminals 70. Thereby, the convenience is improved because information stored in the WEB server 60 may be referred to from the terminals 70 connected to the WEB server 60 through network 86. However, the present invention is not limited to the present embodiment shown in FIG. 1. Here, it is acceptable that the WEB server 60 may be a storage device which is connected to a plurality of the terminals 70 through a network, and which includes information which can be referred to from the terminals 70.

A serial communication network over LAN, RS-232C, USB, and the like may be used for the network 80 and the network 82, and an intranet in an enterprise may be used for the network 84 and the network 86.

Each equipment group 10 comprises a plurality of semiconductor manufacturing devices (not shown in the drawing) of the same kind, and the host computer 32 collects various kinds of information, for example, the actual processing time from each of the semiconductor manufacturing devices. Various kinds of information are transmitted from the host computer 32 to the operation management server 20 and the lot history server 30 through the network 80 as required. Here, FIG. 1 shows a configuration, as an example, in which one host computer 32 is connected to the plurality of the equipment groups 10 through the network 80. However the present invention is not limited to the above example. There may be applied another configuration in which each of the equipment group 10 is provided with a host computer 32, and is connected to the network 80 through the host computer 32 provided in each of the equipment group 10.

The operation management server 20 receives operation management information for each of the equipment groups 10 through the network 80 to accumulate and manage the operation management information, wherein the operation management information is reported from the host computer 32. The operation management information may include information on, for example, report dates, operation statuses, lot numbers, executed processes, product names, numbers of wafers, and the like, which are obtained when operation information is received from each of the equipment groups 10. However the present invention is not limited to the above example. The operation statuses may be classified into, for example, “wait”, “operative preparation”, “actual operation”, “scheduled maintenance”, “off-line”, and “failure”.

The lot history server 30 receives lot history information representing the operation histories of product lots in each equipment group 10 reported from the host computer 32 through the network 80 to accumulate and manage the received lot history information. The lot history information may include information on, for example, names, product names, procedures, processes, equipment, operation devices, operation start dates and operation completion dates, conditions, numbers of processed wafers, rework information, rework flag, and the like for each lot. However the present invention is not limited to the above example.

As described above, the host computer 32 acquires various kinds of information from each equipment group 10 for control of each equipment. The host computer 32 may acquire, for example, the actual processing time from the equipment through the network 80 each time a product is processed. Alternatively, there may be also applied another configuration in which the host computer 32 registers a predetermined set value for the actual processing time of the equipment beforehand and processes a product according to the set value. Specifically, information on, for example, a main polishing time for each platen, a lamp up time, a water polishing time, head operation rates of a plurality of heads, and the like may be acquired from a chemical mechanical polishing (CMP) device, and may be transmitted to the OEE measuring PC 40 through the network 82. The above information is thus used, in the OEE measuring PC 40, for calculating the actual processing time and the equipment loss time.

The predetermined set value for the actual processing time of the equipment may be registered in the database server 34 beforehand. The reason why the actual processing time is registered in the database server 34 beforehand is that there are some cases in which the actual processing time may not be acquired from the equipment.

The OEE measuring PC 40 acquires the operation information and the lot history information from the operation management server 20 and the lot history server 30, respectively, through the network 82, measures an OEE, and creates OEE matrix information, OEE trend graph 42, and the like for presentation. More details of the OEE measuring PC 40 will be described later.

The equipment load factor calculating PC 50 acquires the OEE matrix information generated by the OEE measuring PC 40 through the network 84, and calculates the equipment load factor, based on an improvement plan table 52 input by an operator. More details of the equipment load factor calculating PC 50 will be described later.

The WEB server 60 is connected to the OEE measuring PC 40 and the equipment load factor calculating PC 50 through the network 84, receives data from each PC, stores the received data, and provides the above information to a plurality of the terminals 70 through the network 86. Each terminal 70 includes, for example, a personal computer, a workstation, a dedicated computer, a personal digital assistant (PDA), a mobile terminal, and the like. The terminal 70 has a browse function, and may access to the WEB server 60 through the network 86. The terminal 70 may have a configuration in which an operation unit (not shown in the drawing) is operated, a menu screen provided from the WEB server 60 is displayed on a display unit (not shown in the drawing), various kinds of information are input from the screen, and is transmitted to the WEB server 60 through the network 86.

As shown in FIG. 2, the OEE measuring PC 40 includes: an interface unit (I/F) 102; a registration ledger storage unit (denoted by “registration ledger” in the drawing) 104; the data receiving unit 106; an interface unit (I/F) 112; a data transmission unit 114; an operation information storage unit (denoted by “operation information” in the drawing) 120; a lot history information storage unit (denoted by “lot history information” in the drawing) 122; a clock 108; a measurement unit 130; an actual-processing-time storage unit (denoted by “actual processing time” in the drawing) 132; a loss time storage unit (denoted by “loss time” in the drawing) 134; the accumulating unit 136; the accumulated result storage unit (denoted by “accumulated result” in the drawing) 138; and a trend graph creating unit 140.

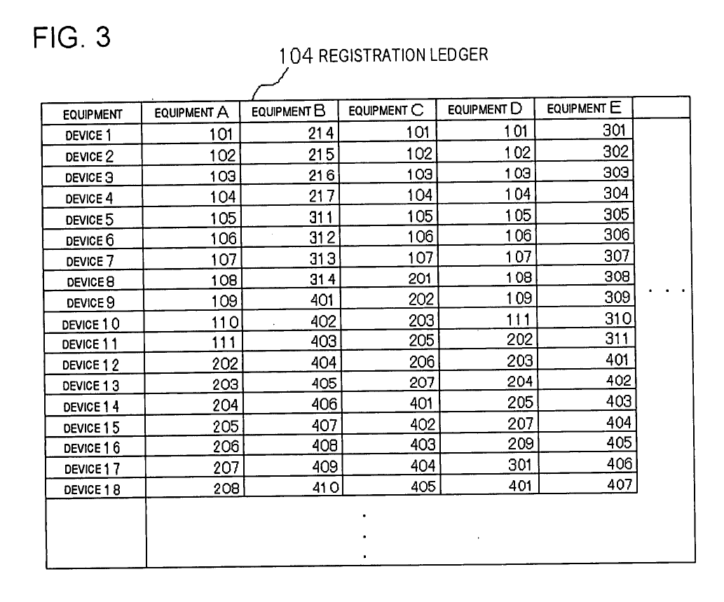

The interface unit 102 conducts communication with the operation management server 20 and the lot history server 30 through the network 82. It is acceptable that either wireless communication, or wired one may be used for the network 82. Information on an equipment to be measured is registered beforehand and stored in the registration ledger storage unit 104 in the OEE measuring PC 40 of the equipment management system 1. Registration of equipment group 10 to be measured may be performed by a configuration in which information input by an operator with an operation unit (not shown in the drawing) such as keyboards is received, or by another configuration in which a registration table prepared beforehand is received or input through a network (not shown in the drawing) or a recording medium (not shown in the drawing) for reading. FIG. 3 shows one example of the registration ledger stored in the registration ledger storage unit 104.

The data receiving unit 106 requires information on an equipment group 10 registered in the registration ledger storage unit 104 of the operation management server 20 and the lot history server 30 on the network 82 through the interface unit 102, and receives the above information on the equipment group 10 for storage in the operation information storage unit 120 and the lot history information storage unit 122, respectively. Moreover, the data receiving unit 106 regularly collects information from the operation management server 20, the lot history server 30, the host computer 32, and the database server 34 according to a period and a date registered in the registration ledger storage unit 104.

The operation information storage unit 120 stores operation information on each of the semiconductor manufacturing devices in each of the equipment groups 10, wherein the operation information is received by the data receiving unit 106. Furthermore, the operation information storage unit 120 stores information on the actual processing time for each of the semiconductor manufacturing devices in each of the equipment groups 10, wherein the information is received and acquired from the host computer 32 and the database server 34 by the data receiving unit 106. The lot history information storage unit 122 stores lot history information for each of the semiconductor manufacturing devices in each of the equipment groups 10 wherein the lot history information is received by the data receiving unit 106. The measurement unit 130 automatically measures an actual processing time of a product, and an equipment loss time without an additional value for each of the semiconductor manufacturing devices in each of the equipment groups 10 according to the operation information and the lot history information.

An actual processing time and an equipment loss time may be defined beforehand, and a measurement method may be decided beforehand for each of the equipment kinds from, for example, a device structure and a wafer flow in a manufacturing process. For example, with regard to the CMP device, the actual processing time may be calculated by acquiring a main polishing time for each platen from the host computer 32, by acquiring a lamp up time and a water polishing time for each platen from database server 34, and by summing the main polishing time, the lamp up time and the water polishing time for each platen after combining the above acquired data. Here, the above example is just one example, and different definitions are made, depending on each system and each equipment for each calculation.

As the equipment loss time is classified into eight segments as will be described in the following, considering the features thereof, the equipment loss time is called eight segment loss times. Moreover, one loss sub-segment includes some sub-segments, and a time obtained by summing all the sub-segments is calculated as a loss time for each sub-segment.

### (1) Schedule maintenance loss (PM);

### (2) Failure loss (USDT);

### (3) Changeover (C-OVER);

### (4) Setup (SET UP);

### (5) Test time (TEST);

### (6) Idle time (IDLE);

### (7) Speed loss (S-LOSS); and

### (8) Rework loss (REWORK).

The scheduled maintenance loss is a processing stopping time during product processing, caused by regular check and scheduled maintenance. The scheduled maintenance loss may be calculated, for example, by accumulating times of “scheduled maintenance” on the operation status of the operation information. The failure loss is a processing stopping time during product processing, caused by failure and a maintenance operation for improvement and remodeling.

The failure loss may be calculated, for example, by accumulating times of “failure” and “off-line” on the operation status of the operation information.

Alternatively, the head cancellation time can be calculated, based on a head operation rate acquired from the host computer 32. The failure loss may be also obtained by summing the above time. The changeover is a time during which the device cannot perform product processing of a product due to movement of a wafer. The setup is a time during which a preliminary operation is performed for an additional-value operation.

The test time is a time during which process checking such as monitoring of garbage and a film thickness, other than product processing, is executed. The test time may be calculated, for example, by accumulating times from an operation start time to a completion report time for a test lot, using the lot history information. The idle time is a time during which a device is in a ready state for wafer processing and in an unloaded state. The idle time may be calculated by accumulating times of “wait” on the operation status of the operation information.

The speed loss is a down loss of a device use efficiency per one piece of a wafer. The down loss may be calculated, for example, by accumulating times caused by differences in the polishing time between platens, by accumulating times caused by differences in the polishing time between continuous preceding and subsequent lots and by summing the above times. That is, it is assumed, for example, that, when main polishing, lamp up processing, and water polishing are conducted for three platens, a polishing time for a platen 1 is 60 seconds, a polishing time for a platen 2 is 58 seconds, and a polishing time for a platen 3 is 40 seconds. As 60 seconds is required for polishing at the platen 1, and 40 seconds are required for polishing at the platen 3, processing at the platen 1 is at a rate-determining step to cause a state in which processing at the platen 3 is required to wait 20 seconds for the subsequent processing and processing at the platen 2 is required to wait two seconds for the subsequent processing, though the subsequent processing is in a ready state at the platen 3. Here, it is assumed that a conveying time between platens is zero. Thereby, a speed loss between platens per one piece of a wafer is 20 seconds.

The rework loss is a time during which an operation related with a rework product is performed. The rework loss may be calculated, for example, by accumulating a time from an operation start time to a completion report time for a lot in which a rework flag of the lot history information is set.

A measured actual processing time is stored in the actual processing time storage unit 132, and measured eight segment loss times are stored in the loss time storage unit 134.

The accumulating unit 136 performs the following accumulating operations, based on the actual processing time and the loss time which have been automatically measured by the measurement unit 130:

(1) OEE data including an actual processing time and eight segment loss times is accumulated for each semiconductor manufacturing device. Here, the OEE data may be represented in hours, for example, by second/piece.

### (2) The average value of the OEE data is calculated for each semiconductor manufacturing device.

The above accumulating operations may be realized by loop processing for each device in each equipment, or for each device kind in each equipment group 10.

An accumulated result file, which include the OEE data (the actual processing time and the eight segment loss times) calculated by the accumulating unit 136 for each device and the OEE-data average value for each device kind, is stored in the accumulated result storage unit 138. From data in the accumulated result file, the trend graph creating unit 140 creates an OEE matrix information file including the average of the OEE data for each device kind for each day of the measurement.

The OEE matrix information may include, for example, the eight segment loss times, the OEE, a number of processed wafers within a predetermined period, a number of equipments to be measured, and average values for each numerical value for each equipment group 10. Furthermore, the trend graph creating unit 140 creates an OEE matrix table and an OEE trend graph from data in the OEE matrix information file, and the above table and the above graph are stored in the trend graph storage unit 142.

The data transmission unit 114 transmits the accumulated result file stored in the accumulated result storage unit 138, and the OEE matrix information, the OEE matrix table and the OEE trend graph, which are stored in the trend graph storage unit 142, to the WEB server 60 on the network 84 through the interface unit 112. As the above data is stored in the WEB server 60, the OEE matrix table and the OEE trend graph may be referred to from a plurality of the terminals 70 on the network 86. Moreover, the equipment load factor calculating PC 50 on the network 84 may also acquire the OEE matrix information by accessing the WEB server 60 through the network 84, and may calculate equipment load factor as required on an automatic basis, or at any time. Alternatively, the equipment load factor calculating PC 50 may acquire the OEE matrix information directly from the OEE measuring PC 40 through the network 84.

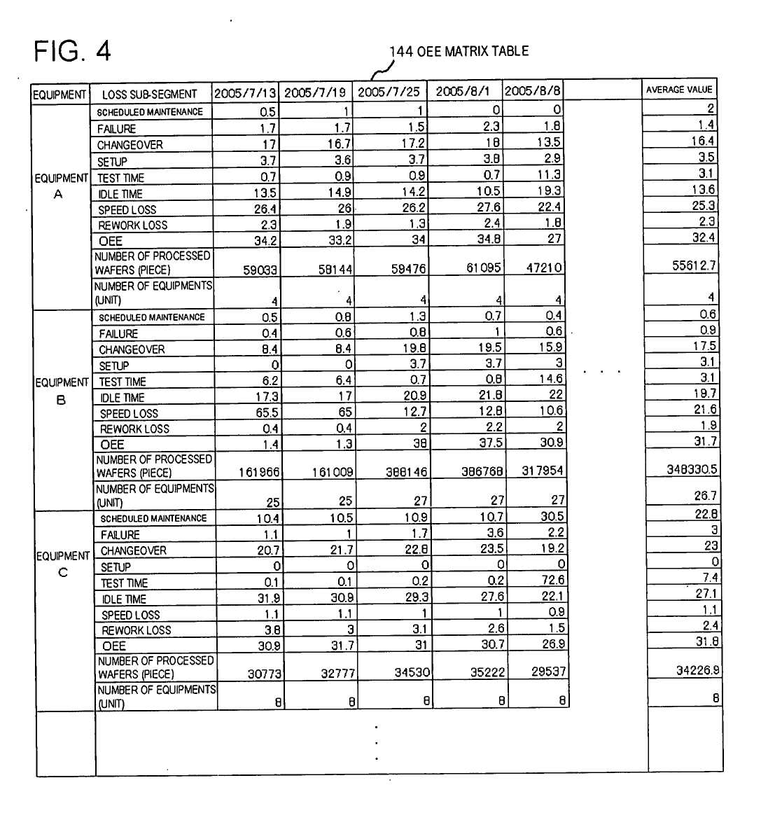

FIG. 4 shows one example of an OEE matrix table 144 created by the OEE measuring PC 40 according to the present embodiment. The OEE matrix table 144 may include data obtained by accumulating data measured regularly, for example, every six days or seven days, for example, the eight segment loss times, the OEE, the number of processed wafers within the predetermined period, the number of equipments to be measured, and the average values for each numerical value for each equipment group 10. Here, the accumulated value may be a value obtained by accumulating OEE data for a predetermined period (for example, six days to seven days), and by calculating an average value for one day, or a value acquired by accumulating the data for a predetermined period (for example, one day and or several days) on a regular basis (every, for example, six days or seven days).

Now, the equipment load factor calculating PC 50 includes, as shown in FIG. 5: an interface unit (I/F) 150; a data receiving unit 152; an OEE data storage unit (denoted by “OEE data” i the drawing) 154; a data transmission unit 156; an improvement plan storage unit (denoted by “improvement plan” in the drawing) 160; the plan input accepting unit 162; the plan update unit 164; the OEE data correction unit 170; the equipment load factor calculating unit 172; the equipment load factor storage unit (denoted by “equipment load factor” in the drawing) 174; and a list creating unit 176.

The interface unit 150 conducts communication with the OEE measuring PC 40 and the WEB server 60 through the network 84. It is acceptable that either wireless communication, or wired one may be used for the network 84. The data receiving unit 152 reads the OEE matrix information from the WEB server 60 on the network 84 through the interface unit 150, and the OEE matrix information is stored in the OEE data storage unit 154. The data transmission unit 156 transmits data stored in the OEE data storage unit 154, the improvement plan storage unit 160, and the equipment load factor storage unit 174 to the WEB server 60 on the network 84 through the interface unit 150. As the above data is stored in the WEB server 60, various kinds of information, which will be described later, may be referred to from a plurality of the terminals 70 on the network 86.

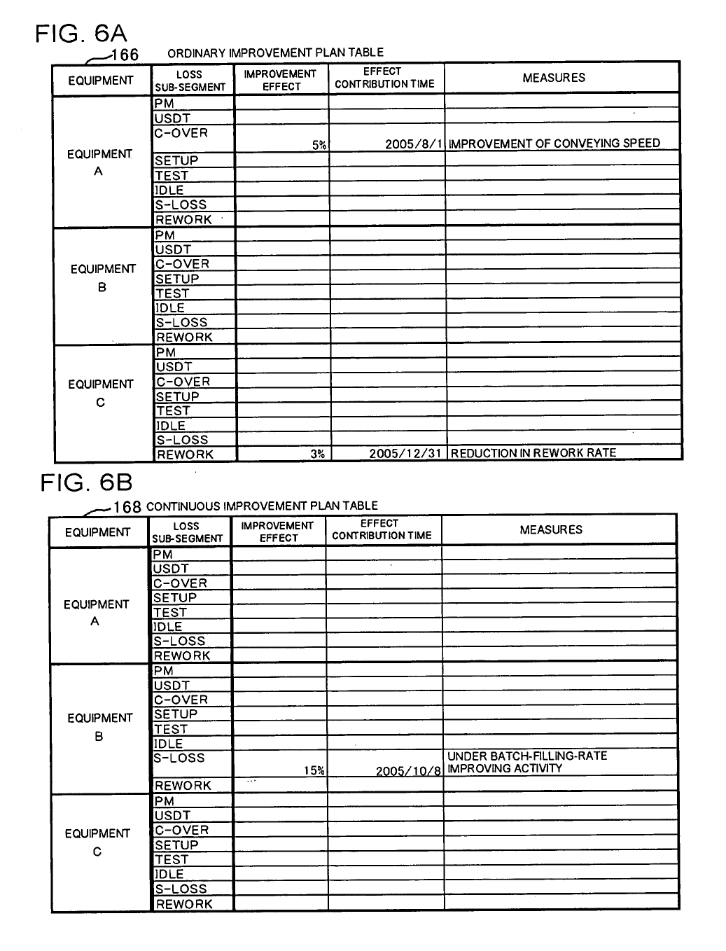

The improvement plan storage unit 160 stores an improvement plan table. In the present embodiment, the improvement plan table may be configured to be a general tabular file which is possibly referred to from, for example, a general-purpose spreadsheet program. FIGS. 6A and 6B show examples of an improvement plan table stored in the improvement plan storage unit 160. FIG. 6A shows one example of an ordinary improvement plan table 166, and FIG. 6B shows a continuous improvement plan table 168. Returning to FIG. 5, the plan input accepting unit 162 accepts data of the improvement plan table of which an operator opens the file on the display unit (not shown in the drawing) for display, and to which an operator inputs the data, using the operation unit (not shown in the drawing). Alternatively, it is acceptable that a file updated at the terminal 70 and the like is stored in the WEB server 60, and the plan input accepting unit 162 accepts the file transmitted from the WEB server 60 through the interface unit 150. The plan update unit 164 updates the data of the improvement plan table in the improvement plan storage unit 160 according to the data of the improvement plan table accepted by the plan input accepting unit 162. Alternatively, updating may be realized by overwriting the improvement plan storage unit 160 with a file accepted by the plan input accepting unit 162.

The OEE data correction unit 170 corrects the OEE included in the OEE matrix information stored in the OEE data storage unit 154, based on the tendency over time. For example, when the OEE shows an upward or a downward tendency, the OEE data correction unit 170 conducts correction, based on the inclination of the change over time. The equipment load factor calculating unit 172, which will be described later, may perform prediction, using the corrected OEE. Here, the inclination of the change over time may be calculated by using a technique such as the least square method, based on measured values.

Alternatively, the OEE data correction unit 170 may conduct correction in such a way that data is eliminated when the change over time of the OEE is deviated from a predetermined range (called a management limit value), for example, when the data exceeds 3σ. Thereby, the accuracy of the equipment load factor is improved because the corrected result of the OEE is used to predict a future OEE on the basis of the tendency over time, and the equipment load factor may be calculated by using the future OEE.

The equipment load factor calculating unit 172 predicts a future equipment load factor for each equipment, based on the OEE data corrected by the OEE data correction unit 170 and the data of the improvement plan table stored in the improvement plan storage unit 160. Moreover, the equipment load factor calculating unit 172 may calculate the following data:

### (1) A required time per one piece of a product=an actual processing time (averaged value) required for processing of one piece of the product+eight segment loss times (averaged value);

### (2) Processing performance (piece)=an effective operating time of an equipment/the required time for one piece of a product;

### (3) An equipment load factor (%)=a required number of processed products (specified value)/a number of processed products×100 (%); and

### (4) A number of required equipments (unit)=a current number of equipments (specified value)/the equipment load factor.

Here, the accumulated result of the actual processing time and the eight segment loss times is corrected by the above-described OEE data correction unit 170, and the corrected result is reflected on the equipment load factor.

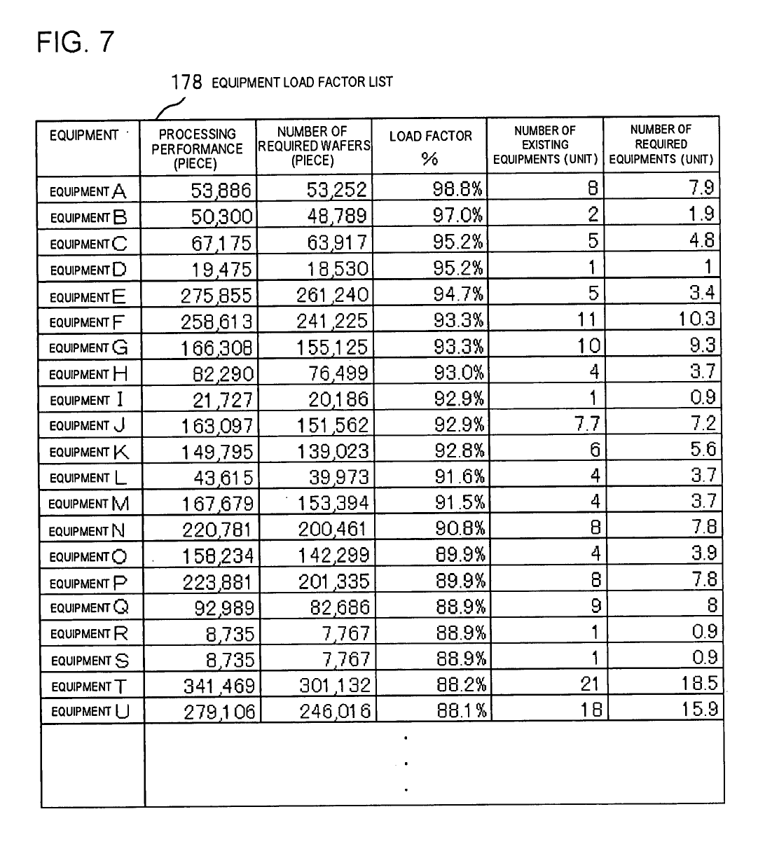

The equipment load factor storage unit 174 stores the future equipment load factor and the above-described data, which have been calculated by the equipment load factor calculating unit 172. The list creating unit 176 creates a list from the equipment load factor and the above-described data calculated by the equipment load factor calculating unit 172 to store the list in the equipment load factor storage unit 174. FIG. 7 shows one example of an equipment load factor list 178 created by the list creating unit 176 in the equipment load factor calculating PC 50. The future equipment load factor and the above-described data stored in the equipment load factor storage unit 174, and the equipment load factor list 178 created by the list creating unit 176 are transmitted to the WEB server 60 through the interface unit 150 by the data transmission unit 156 as described above. As the above data is stored in the WEB server 60, the above data can be referred to from a plurality of the terminals 70 on the network 86.

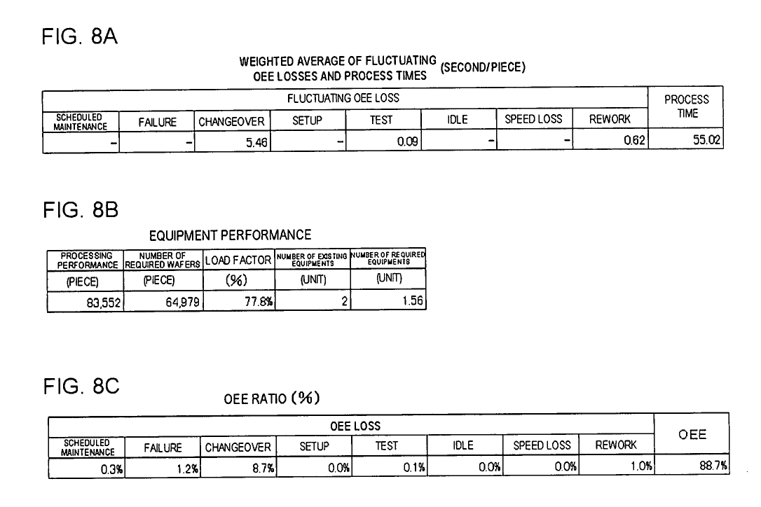

FIGS. 8A through 8C show examples of other lists created by the equipment load factor calculating PC 50. FIG. 8A shows a list of a weighted average of fluctuating OEE losses and process times. The fluctuating loss means a loss fluctuating according to product processing conditions, a number of processed products, a number of processed batches, and the like, while a fixed loss means a loss independent of the product processing conditions, the number of processed products, the number of processed batches, and the like. The fluctuating loss and the fixed loss are defined for each equipment. Generally, the changeover, the speed loss, the setup, the test time, and the rework loss may belong to the fluctuating loss in many cases, and the scheduled maintenance loss, and the failure loss often may belong to the fixed loss. However, there is another case, as the scheduled maintenance loss of a CMP device, in which maintenance performed according to a piece number of processed products, and maintenance independent of the piece number of the processed products are included, the loss extends over both the fluctuating and the fixed losses (in this case, definition is made according to sub-segments). Moreover, as the equipment load factor is calculated, assuming that there is no product latency, the idle time is treated as zero in a similar manner to those of the fluctuating loss and the fixed loss. FIG. 8B shows a list of the equipment performance. FIG. 8C shows a list of the OEE ratio. An actual processing time ratio (OEE ratio), and ratios of eight segment loss times are shown. For example, in the equipment load factor calculating PC 50 according to the present embodiment, the equipment load factor calculating unit 172 may further include an equipment number calculating unit (not shown in the drawing) calculating a number of equipments to be required in the future, based on the equipment load factor. Moreover, the list creating unit 176 may further include a list creating unit (not shown in the drawing) creating a list of predicted results, wherein the table includes the OEE and the equipment load factor in the future.

Hereinafter, the following items will be explained:

### (1) A fluctuating OEE loss (second/piece)=A weighted average of OEE losses under each condition with each number of products to be required;

### (2) A process time (actual processing time) (second/piece)=a weighted average of process times under each condition with each number of products to be required;

### (3) Processing performance (piece)=an effective operating time (second)/(the fluctuating OEE loss (second/piece)+the process time (second/piece));

### (4) A number of products to be required (piece)=a number of products to be processed by the related equipment (piece);

### (5) A load factor (%)=(the number of products to be required (piece)/the processing performance (piece))×100 (%);

### (6) A number of existing equipments (unit)=a number of the related existing equipments (unit);

### (7) A number of required equipments (unit)=the number of the existing equipments (unit)×the load factor

### (8) An OEE loss (%)=a fluctuating OEE loss ratio of the related equipment (%)+a fixed OEE loss ratio (%)

### (9) A fluctuating OEE loss ratio (%)=the fluctuating OEE loss (time/piece)×processing performance per unit time (piece/time unit);

### (10) An OEE (%)=a process time ratio of the related equipment (%); and

### (11) A process time ratio (%)=a process time (time/piece)×processing performance per unit time (piece/time·unit).

As various kinds of data including a number of equipments to be required in the future may be calculated, a user may judge beforehand whether a product infusion plan is realized, which of equipment is superior in improvement activities, and whether equipment investment is required or not. Moreover, points to be improved may be more easily specified, because predicted results may be expressed as a list. Furthermore, the above lists may be referred to from the terminals 70 through the network 86 by the above data being stored in the WEB server 60.

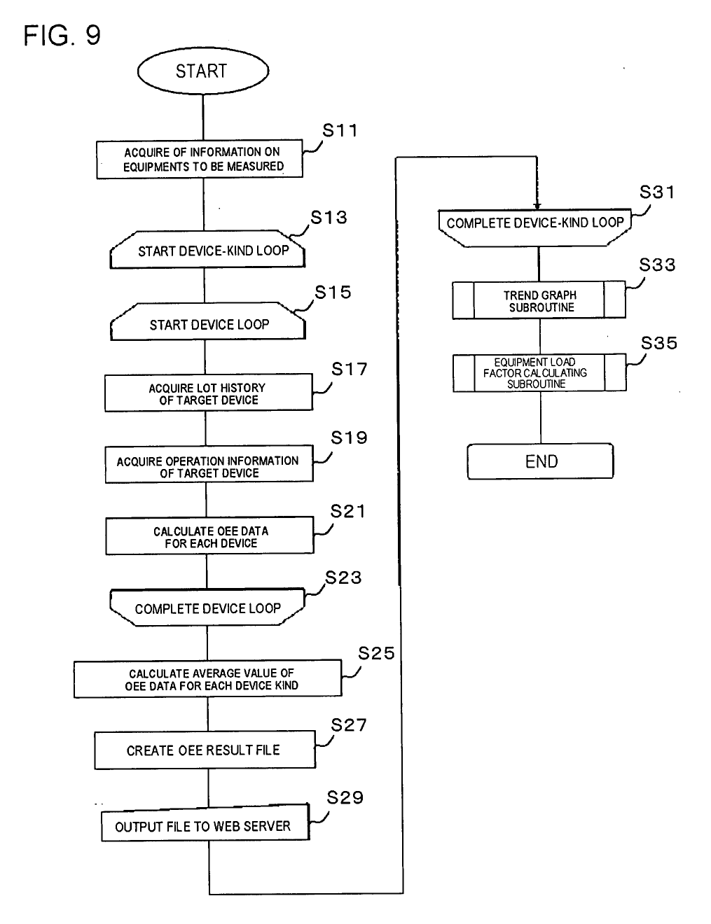

FIG. 9 is a flow chart showing a processing flow of the equipment management system 1 according to the present embodiment. In the present embodiment, the processing according to the above flow chart is required to be executed regularly. Moreover, information on equipments to be measured is required to be registered in the registration ledger storage unit 104 beforehand.

Firstly, in the OEE measuring PC 40, the data receiving unit 106 reads out to acquire information on the equipments to be measured, from the registration ledger storage unit 104 (step S11). Then, a processing loop for each device kind corresponding to the equipment group 10 is started during a collecting period or at a date registered in the registration ledger storage unit 104, referring to the clock 108 (step S13). Though the plurality of the semiconductor manufacturing devices are provided in each equipment group 10, a processing loop for each device kind is started (step S15). In the above processing loop, the data receiving unit 106 acquires the lot history information for a device of interest from the lot history server 30 on the network 82 through the interface unit 102 in the first place, and stores the lot history information in the lot history information storage unit 122 (step S17). Furthermore, the data receiving unit 106 acquires the operation information for the device of interest from the operation management server 20 on the network 82 through the interface unit 102, and stores the operation information in the operation information storage unit 120 (step S19).

Then, the measurement unit 130 measures the actual processing time and the eight segment loss times for each device, using the operation information and the lot history information respectively acquired at the step S17 and the step S19 (step S21). The measured actual processing time is stored in the actual processing time storage unit 132, and the measured eight segment loss times are stored in the loss time storage unit 134.

Processing at steps S17 through S21 is similarly repeated for a plurality of the devices to be measured included in the equipment group 10, and, with regard to all the devices of the equipment group 10 to be measured, the actual processing time and the eight segment loss times are measured to store the measured actual processing time in the actual processing time storage unit 132, and the measured eight segment loss times in the loss time storage unit 134 (step S23).

Subsequently, the accumulating unit 136 accumulates the actual processing times and the eight segment loss times, which are measured at the step S21, for each device kind to calculate average values (step S25). The accumulating unit 136 makes an accumulated result file to store the accumulated result file in the accumulated result storage unit 138 (step S27). Then, the data transmission unit 114 transmits the accumulated result file to the WEB server 60 on the network 84 through the interface unit 112 (step S29).

Processing at steps S15 through S29 is similarly repeated for a plurality of the device kinds corresponding to the plurality of equipment groups to be measured. An accumulated result file is made for all the equipment groups 10 to be measured, the file is transmitted to the WEB server 60 (step S31). Subsequently, the processing proceeds to a trend graph subroutine processing (step S33). Thereafter, the processing proceeds to an equipment load factor calculating subroutine processing (step S35). Subsequently, the processing is completed.

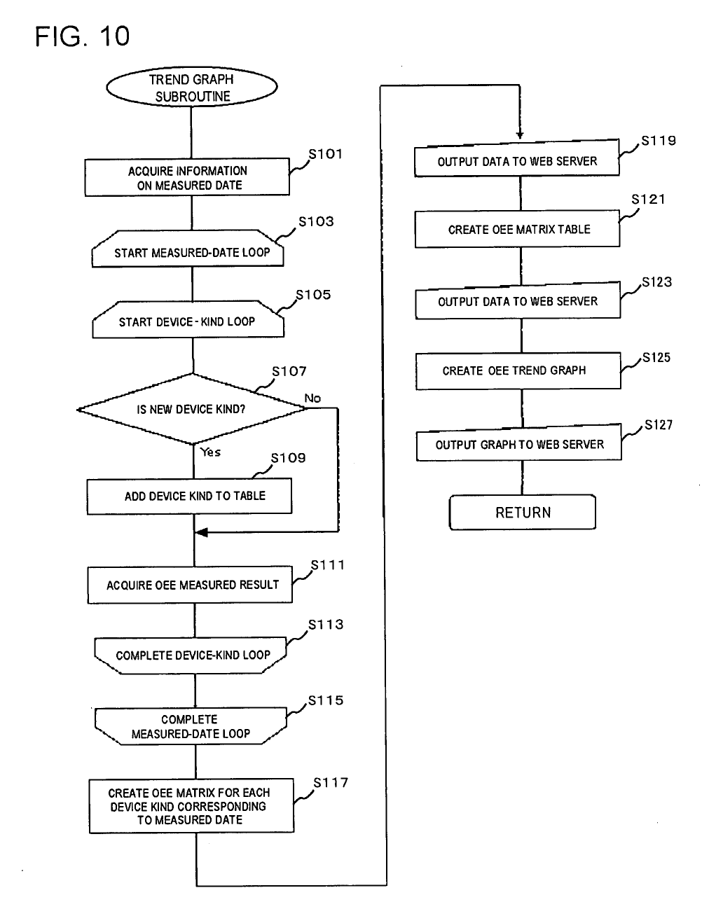

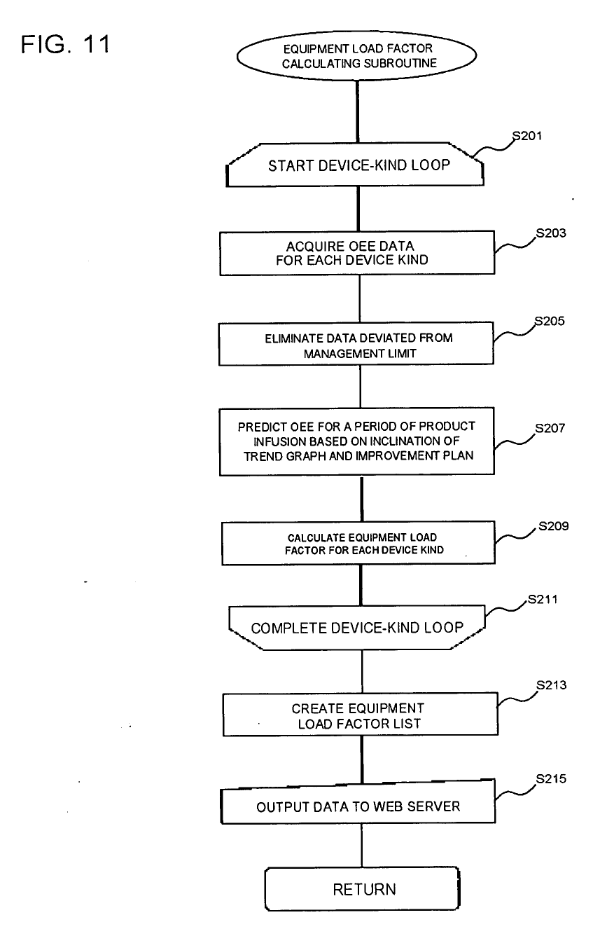

FIG. 10 is a flow chart showing one example of the trend graph subroutine in the flow chart shown in FIG. 9. FIG. 11 is a flow chart showing one example of the equipment load factor calculating subroutine in the flow chart shown in FIG. 9.

In FIG. 10, the trend graph creating unit 140 in the OEE measuring PC 40 executes the following processing. In the first place, information on measured dates for the actual processing time recorded in the actual processing time storage unit 132, and the eight segment loss times recorded in the loss time storage unit 134 are acquired (step S101). Alternatively, there may be another configuration in which specified information on the measured dates is received by input of an operator with the operation unit. Then, a processing loop repeating the following processing is started for each measured date (step S103) Furthermore, the processing loop repeating the following processing is started for each device kind corresponding to each equipment group 10 (step S105).

In the first place, information on the device kinds of the acquired OEE data (the actual processing time and the eight segment loss times) is referred to. When a new device kind is found (YES at the step S107), information on the new device kind is transmitted to the trend graph creating unit 140, and the transmitted information is added to and registered in a device kind table (not shown in the drawing) for the OEE matrix table 144 (step S109). When a new device kind is not found (NO at the step S107), or, after step S109, an accumulated result file is acquired from the accumulated result storage unit 138 (step S111).

Processing at steps S107 through S111 is similarly repeated for a plurality of the device kinds corresponding to devices in the plurality of equipments, which are registered in the registration ledger storage unit 104, among the plurality of equipment groups 10, to acquire OEE data for all the plurality of equipment groups 10 (step S113). Then, processing at steps S105 through S113 is similarly repeated for data on the same measured date, and, when there exists data on another measured date, the processing is similarly repeated for data on the another measured date to complete acquisition of the OEE data for data on all the plurality of measured dates (step S115).

Then, OEE matrix information for each device kind corresponding to measured dates is made from the acquired OEE data (step S117). Here, the information is made for each of corresponding device kinds, based on the data in the registration ledger storage unit 104. Then, the made OEE matrix information is stored in the trend graph storage unit 142. Then, the data transmission unit 114 transmits the OEE matrix information to the WEB server 60 on the network 84 through the interface unit 112 (step S119).

Subsequently, the trend graph creating unit 140 creates the OEE matrix table 144 shown in FIG. 4 from the OEE matrix information made at the step S117 (step S121). Then, the data transmission unit 114 transmits the made OEE matrix table 144 to the WEB server 60 on the network 84 through the interface unit 112 (step S123)

Furthermore, the trend graph creating unit 140 creates an OEE trend graph (step S125), using the OEE matrix table 144 made at the step S121. Then, the data transmission unit 144 transmits the made OEE trend graph to the WEB server 60 on the network 84 through the interface unit 112 (step S127). After the step S127, the processing returns to the flow shown in FIG. 9 to complete the subroutine processing.

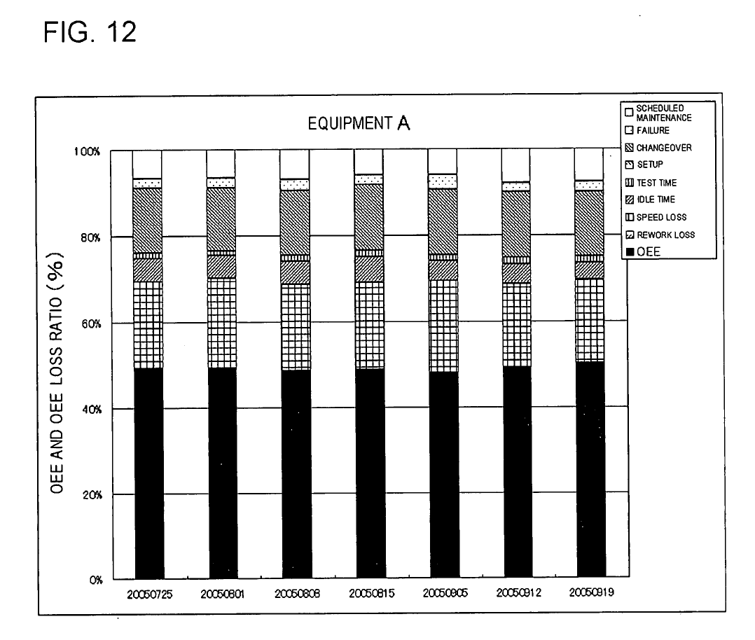

As described above, the OEE matrix information for each device kind, the OEE matrix table 144, and the OEE trend graph, which are transmitted to the WEB server 60, may be referred to, as required, from the plurality of the terminals 70 connected to the WEB server 60 through the network 86. At this time, various kinds of information may be referred to by a simple configuration when the terminal 70 is configured to have a browse function. FIG. 12 is a view showing an accumulation graph as one example of an OEE trend graph, using the equipment “A” as an example. It is acceptable to use a line graph, which will be described, as another example of the OEE trend graph. However, the form of the graph is not specifically limited to the above examples. It is easier to specify a point to be improved because, according to the OEE trend graph, breakdowns of the eight segment loss times and a tendency over time of the OEE are expressed as a graph for each of the plurality of equipments as shown in FIG. 12.

While specifying one equipment group 10 and the period, the OEE trend graph may be displayed on the display unit (not shown in the drawing) of each terminal 70 by access to the WEB server 60 through the network 86 from each terminal 70. It is easier to specify a point to be improved because tendencies over time of the OEEs of the plurality of equipments under operating may be expressed as a graph as described above.

Subsequently, a processing loop for each device kind corresponding to one equipment group 10 is started in the equipment load factor calculating PC 50 (step S201). The data receiving unit 152 receives the OEE data for each device kind from the OEE measuring PC 40 through the interface unit 150 (step S203). Then, the OEE data correction unit 170 eliminates data beyond a range of a management limit (step S205). Then, the OEE data correction unit 170 predicts OEEs in the future (product infusion time) from the data in the corrected results and the improvement plan table, based on an inclination (tendency over time) of the graph (step S207). Then, the equipment load factor calculating unit 172 calculates equipment load factors for each device kind (step S209).

Processing at steps S203 through S209 is similarly repeated for a plurality of the device kinds corresponding to devices in the plurality of equipment groups 10 to perform similar processing for all the plurality of equipment groups 10 (step S211). Then, a list is made from the equipment load factors for each equipment group 10 (step S213), wherein the equipment load factors are calculated at the step S209.

Subsequently, the data transmission unit 114 transmits the OEE matrix information to the WEB server 60 on the network 84 through the interface unit 112 (step S215).

According to the embodiment of the equipment management system 1 according to the present invention, OEEs and equipment load factors in the future may be efficiently calculated for a plurality of equipments under operating as explained above. That is, the operation statuses of a plurality of equipments under operating may be automatically collected, OEEs in the future may be predicted from the OEEs accumulated in a regular base according to the improvement plan, equipment load factors in the future may be calculated, based on the predicted results, and the above information may be stored to contribute to an equipment infusion plan in the future. Moreover, the accuracy of an equipment load factor may be improved because OEEs in the future may be predicted, using corrected results of the OEEs based on the tendency over time of the OEEs to calculate the equipment load factor.

As described above, configurations according to an embodiment of the present invention have been described, referring to the drawings. However, the above configurations are to be considered only as examples of the present invention, and various kinds of configurations other than the above-described ones may be adopted.

### EXAMPLE

### Example 1

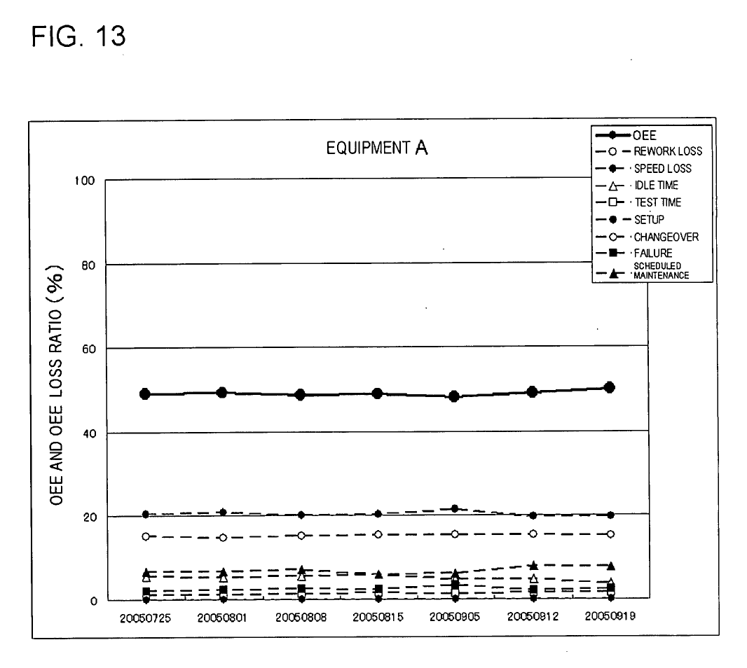

FIG. 13 is a view showing one example of an OEE trend graph, using the equipment “A” as an example, and OEEs are steadily changed therein. In an example, like this example, in which OEEs are steadily changed, an effect is obtained at once when improvement activity is executed. It is assumed, for example, that an improvement plan is set, based on an ordinary improvement plan table 166 shown in FIG. 6A. That is, there will be explained a case in which an improvement plan is made for the equipment “A” as follows: an improvement completion time (effect contribution time): Aug. 1, 2005, an item to be improved: changeover, an effect: 5% reduction.

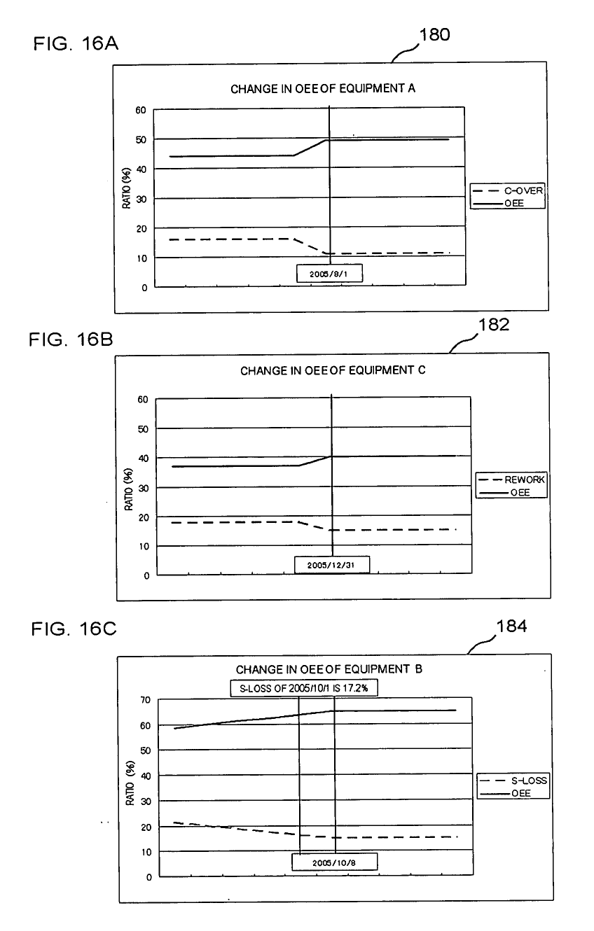

As the changeover is improved on Aug. 1, 2005 with regard to the equipment “A” in this example, an equipment load factor calculating unit 172 calculates an equipment load factor for infusion lots before the date without any changes in the conditions, using an average value of measured values for several months. It is assumed that, as shown in an OEE change graph 180 for the equipment “A” shown in FIG. 16A, an average value of measured results for a change over ratio up to Jul. 31, 2005 before Aug. 1, 2005 is 16%, and OEE is 44%.

On the other hand, with regard to infusion lots from Aug. 1, 2005, the equipment load factor calculating unit 172 calculates the equipment load factor by subtracting 5% from the average value of the measured values for the changeover of a loss time. That is, an OEE data correction unit 170 corrects the change over ratio from Aug. 1, 2005 to 16−5=11%, and the OEE from the above date to 44+5=49%. Thereby, the OEE changes as shown in an OEE change graph 180 for the equipment “A” shown in FIG. 16A. The equipment load factor calculating unit 172 calculates the equipment load factor, using the corrected OEE data.

### Example 2

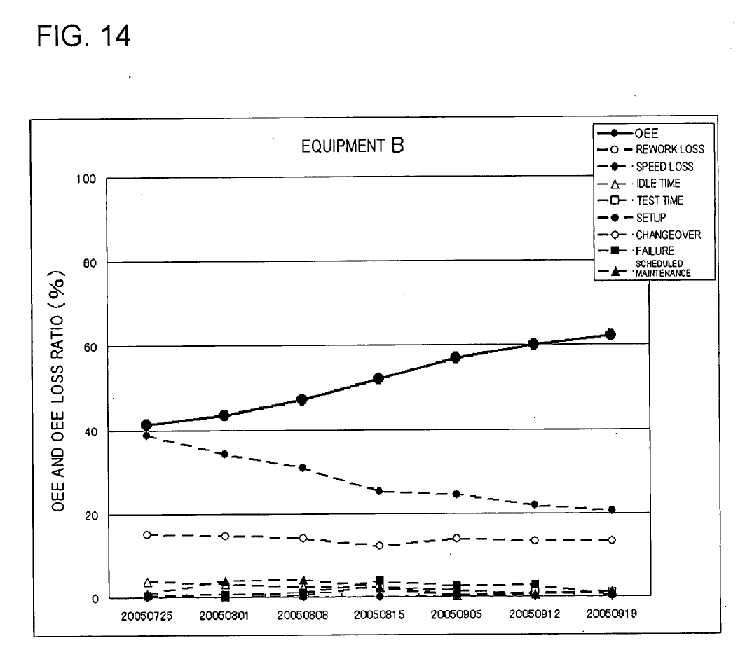

Now, there are many cases, in a semiconductor manufacturing equipment, in which the OEE is not always stable, and unstable values are obtained. FIG. 14 is a view showing one example of an OEE trend graph, using the equipment “B” as an example, and OEEs continuously rise therein.

A batch-filling-rate improvement activity is continuously executed in the equipment “B” as shown in the continuous improvement plan table 168 shown in FIG. 6B. Thereby, speed loss is continuously reduced, and OEE has a upward tendency by the above loss-reduction improvement activity. According to an improvement plan, it is assumed that a target time: Oct. 8, 2005, an item to be improved: speed loss, a limit value: 15%.

In the above case (or the OEE is in a downward tendency by some causes), there is a case, with regard to the equipment load factor calculating PC 50, in which it is judged that product infusion is impossible though the infusion is possible, or it is mistakenly judged that unnecessary equipment investment is required, because the load is higher than the actual value even if an equipment load factor in the future is predicted, simply using the average value of OEEs. Thereby, as described above, the OEE data correction unit 170 has a configuration in which OEE corresponding to a product infusion time in a given infusion plan is assumed from the inclination of the trend graph and the loss reduction activity plan defined by the improvement plan table, and an equipment load factor is calculated, using the assumed value.

It is assumed, for example, that a speed loss ratio up to Jul. 25, 2005 is 39%, and a speed loss ratio at the time of Sep. 19, 2005 is 21%. Moreover, it is assumed that the speed loss may be theoretically reduced by only up to 15% in the above improvement activity. At this time, the inclination of a line of the speed loss ratio is as follows: (39(%)−21(%))/59 (day)=0.32 (%/day). Thereby, a time when 15% of the limit value is reached is (21(%)−15(%))/0.32 (%/day)=18.75 (day). Accordingly, 19 days are required, that is, Oct. 8, 2005 is obtained.

As described above, the OEE data correction unit 170 predicts a speed loss in the future from the tendency of the measured values of the speed loss for correction. For example, the OEE data correction unit 170 corrects the speed loss ratio to 21%−(0.32 (%/day)×12 days=17.2% for product infusion on Oct. 1, 2005. Simultaneously, the OEE is corrected. Thereby, the OEE changes as shown in an OEE change graph for the equipment “B” 184 shown in FIG. 16C.

The equipment load factor calculating unit 172 calculates an equipment load factor up to Oct. 7, 2005 by use of values which are corrected as described above, and from Oct. 8, 2005 by use of the speed loss ratio which is fixed at 15%.

### Example 3

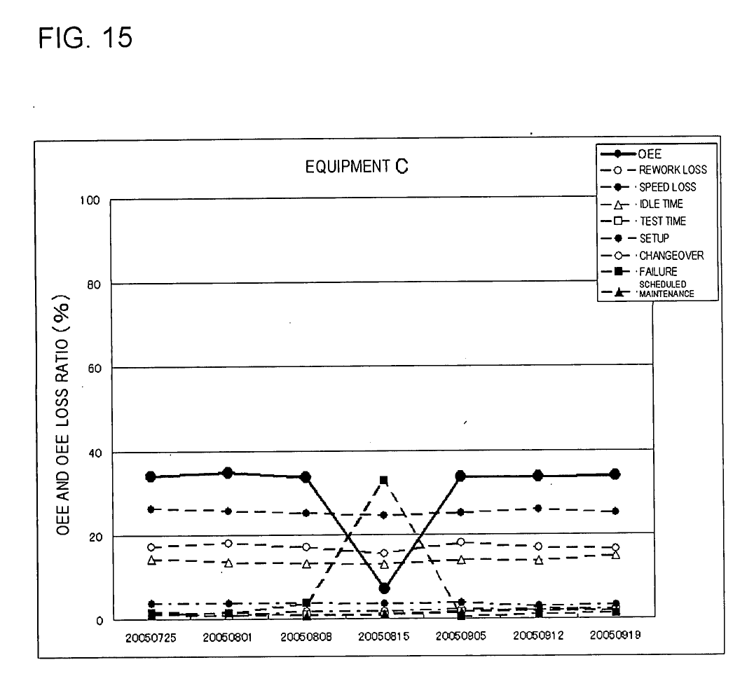

FIG. 15 is a view showing one example of an OEE trend graph, using the equipment “C” as an example, and the OEE is suddenly increased or decreased therein. For the equipment “C” having sudden deviation as described above (data on Aug. 15, 2005), the OEE data correction unit 170 calculates an average value, eliminating a point deviated from the management limit value of each loss ratio. The values calculated here are a failure loss ratio: 3%, a rework loss ratio: 18%, and an OEE: 37%. Moreover, as shown in an ordinary improvement plan table 166 shown in FIG. 6A, it is assumed that a plan is made for the equipment “C” as follows: an improvement completion time (effect contribution time): Dec. 31, 2005, an item to be improved: rework loss, an effect: 3% reduction.

When there were no improvements other than the above-described ones up to Dec. 30, 2005, the conditions are not changed to obtain the following data: a failure loss ratio: 3%, a rework loss ratio: 18%, and OEE: 37%. From Dec. 31, 2005, the rework loss ratio is reduced by 3% according to the improvement plan, the failure loss ratio is not changed at 3%, and the OEE data correction unit 170 corrects as follows: the rework loss ratio: 18−3=15%, and OEE: 37+3=40%. Thereby, the OEE changes as shown in an OEE change graph 182 for the equipment “C” shown in FIG. 16B. With regard to infusion lots from Dec. 31, 2005, the equipment load factor calculating unit 172 calculates the equipment load factor by using the above corrected values.

It is apparent that the present invention is not limited to the above embodiment, that may be modified and changed without departing from the scope and spirit of the invention.

What is claimed is:

1. An equipment management system, comprising:
a collection unit collecting operation status data indicating operation statuses of a plurality of equipments;
an accumulating unit accumulating an actual processing time and a loss time from said operation status data on a predetermined period basis;
an overall equipment efficiency calculating unit calculating an overall equipment efficiency from the accumulated result obtained by said accumulating unit on said predetermined period basis;
an accepting unit accepting information on an improvement plan for said equipment;
a prediction unit predicting a future overall equipment efficiency according to said overall equipment efficiency and said information, on the improvement plan;
an equipment load factor calculating unit calculating a future equipment load factor, based on said future overall equipment efficiency predicted by said prediction unit; and
a storage unit storing equipment management information, which includes said future overall equipment efficiency and said future equipment load factor, for said plurality of equipments.

2. The equipment management system as claimed in claim 1, further comprising a correction unit correcting said overall equipment efficiency calculated by said overall equipment efficiency calculating unit, based on the tendency over time.

3. The equipment management system as claimed in claim 1,
wherein said storage unit is a server, and
said equipment management system further includes a connection unit connecting said storage unit and a terminal connected to said server through a network in such a way that said storage unit is referred to from said terminal.

4. The equipment management system as claimed in claim 1, further including a graph creating unit creating a trend graph for said overall equipment efficiency,
wherein said trend graph is stored in said storage unit.

5. The equipment management system as claimed in claim 1, further including an equipment number calculating unit calculating a number of equipments to be required in the future, based on said equipment load factor.

6. The equipment management system as claimed in claim 1, further including a list creating unit creating a list of predicted results, said list including said future overall equipment efficiency and said future equipment load factor,
wherein said list of predicted results is stored in said storage unit.

7. The equipment management system as claimed in claim 1, wherein said equipment is a semiconductor manufacturing device.
